(19) United States
(12) Patent Application Publication
(10) Pub. No.: US 2005/0039502 A1
(43) Pub. Date: Feb. 24, 2005

(54) Protection device for portable computers

(76) Inventor: Mair Avganim, Mosahv Gealiya (IL)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/497,635

(22) PCT Filed: Feb. 12, 2002
(86) PCT No.: PCT/IL02/00965

(30) Foreign Application Priority Data
Dec. 4, 2001 (IL) 146897

(51) Int. Cl. E05B 73/00

(52) U.S. Cl. 70/58; 361/683

(57) ABSTRACT

A protection device (16) particularly for portable computers (10) having a Universal Serial Bus (USB) socket (12) and a standardized dedicated slot (14) formed in vicinity of the socket (12). A key or the like operable mechanism (18) is provided for rotating a T-shaped tip member (20) which is adapted to be inserted into and locked by the slot (14). Plug (22) may be either a “demo” or part of an active device, which functions to enable/disable the operation of the computer. The device (16) may further be provided with arresting means in the form of a cable (24), which can be tied to an immovable object such as table leg (26) for protecting the computer (10) against theft.

### BACKGROUND OF THE INVENTION

The present invention relates to devices for securing portable articles, mainly computers, against theft. More specifically, the invention concerns security devices adapted to become arrested against a dedicated slot formed at a side wall of portable or desk computer casings, and tied by a cable to a stationary object.

Since the use of portable computers has gained vast popularity during recent years, the problem of their theft became more and more severe. Unattended computers in university libraries, offices and even restaurants are “snatched” within seconds.

Various methods and means have been proposed to solve this problem. The most widespread method presently used is to secure a locking device against a standardized dedicated slot formed (by the manufacturers) at one of the plastic made walls of the computer casing. A steel cable, extending from the locking device is tied to a stationary body such as around a table leg.

Among the locking devices that were developed to implement this method are those disclosed in U.S. Pat. Nos. 5,327,752; 5,447,044; 5,579,657; 6,006,557 and the inventor's U.S. Pat. No. 6,244,082.

The prior art devices have in common the feature that a T-shaped tip or bit member is first inserted into the slot, turned by about 90° which prevents the extraction thereof, and the following insertion of a pin member that prevents the rotation of the T-member back to the initial, releasing position.

These prior art devices suffered the following main disadvantages: (1) the pin insertion and withdrawal mechanism was inherently complicated and therefore costly; (2) the routine of engaging the device was inconvenient; and (3) the device was easily vulnerable to being forced open.

Another proposed method of protection was to employ an electronic “personal” plug, affective to enable the operation of the computer only when applied, i.e. connected to the USB or other suitable socket provided for that purpose (hereinafter referred to as “Active Plug”). This arrangement has been rejected as being inconvenient: The active plug could be lost by the owner, or stolen by others just as an act of sabotage.

It is thus the general object of the present invention to overcome the deficiencies of the conventional methods and devices for the protection of computers against theft and/or unauthorized use.

It is a further object of the present invention to provide a protective, anti-theft device for computers which, on the one hand, is of a much simpler structure, regarded from the mechanical locking aspect, and on the other hand, may also offer electronic protection, namely preventing the unauthorized use of the computer while the device itself is protected against separation from the computer casing.

It is a still further object of the invention to make use of the USB socket found at the back of most computer models as both a mechanical, anti-rotation element, and as an input means for disabling the operation of the computer for use by anyone other than the authorized owner or those in his service.

It is a still further object of the invention to integrate electronic verification and identification means of the biometric or other type for enabling/disabling the operation of the protective device.

### SUMMARY OF THE INVENTION

An arrangement for the protection of computers comprising, in combination, a computer and a plug-in device. The computer comprises a socket comprised at a side wall of the computer and a dedicated slot formed at the side wall at a distance from the socket. The plug-in device comprises a casing, a plug projecting from one side wall of the casing, fitting the said socket, a rotatable T-shaped tip member projecting from said side wall at the said distance from the plug and a key or the like operable mechanism coupled to the tip member for rotation and locking thereof in a pre-set angular position.

The device may further comprise a cable attached thereto at one end and adapted to be tied by the other end thereof to a stationary object.

The device may be either passive or active (as defined below).

### BRIEF DESCRIPTION OF THE DRAWINGS

These and additional constructional features and advantages of the invention will be more clearly understood in the light of the ensuing description of preferred embodiments thereof, given by way of example only with reference to the accompanying drawings wherein—

FIG. 1 schematically illustrates a passive plug-in protection device according to a first preferred embodiment of the invention;

FIG. 2 shows the leading side of the plug-in device of FIG. 1;

FIG. 3 illustrates another embodiment, based on fingerprint recognition technology;

FIG. 4 illustrates another embodiment, based on coded proximity sensor technology; and,

FIG. 5 illustrates still another embodiment based on key-board technology.

### DETAILED DESCRIPTION OF THE PREFERRED EMBODIMENTS

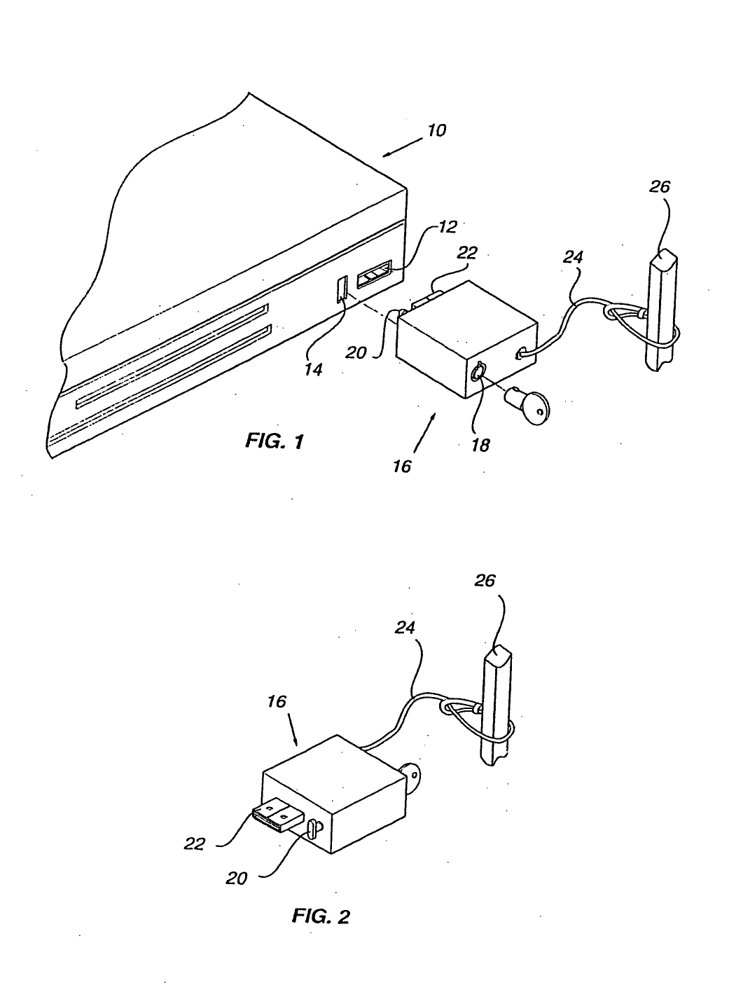

Referring to FIGS. 1 and 2, the implementation of the invention to a portable computer is exemplified, however, it would be readily appreciated by those of ordinary skill in the art that it is equally applicable to most types of desk-computers.

In more detail, computer 10 is supplied as usual, with a Universal Serial Bus (USB) socket 12. Nearby the socket 12, a standardized dedicated slot 14 is formed. The exact location of the slot 14 (i.e. distance from the socket 12) will have to be coordinated between the protection device producers and the computer manufacturers.

The protection plug-in device generally denoted 16 comprises a key operated rotatable lock mechanism 18 of any conventional type, effective to impart controlled, lockable rotational movement to T-shaped tip 20 as known in the art.

As will be explained further below, the plug-in device 16 may be “passive” or “active”. In the former case, plug 22 may be just a “demo”, namely, physically matching the socket 12 but electronically passive, having no effect whatsoever on the operation of the computer. In the latter case (active device), the device 16 includes suitable circuitry coupled to electrical contacts oh the plug 22 and operative, through the USB socket, to switch the computer from a default, non-operative state into an enabled state. In both cases, however, by plugging-in and turning the tip 20 by 90°, the device 16 itself becomes protected against unauthorized removal, as well as serving to counter the rotation of the tip 20 during the locking stage.

As further shown in FIG. 1, the device 16 is provided with arresting means conveniently in the form of steel cable 24 by which it can be tied to an immovable object such as table leg 26 in the known manner. Hence, protection of the computer 10 against theft is achieved.

In summery, if the device 16 is passive, it will only serve as an anti-theft device; if active—it will serve also for user control, namely assuring that the computer is operated by an authorized user.

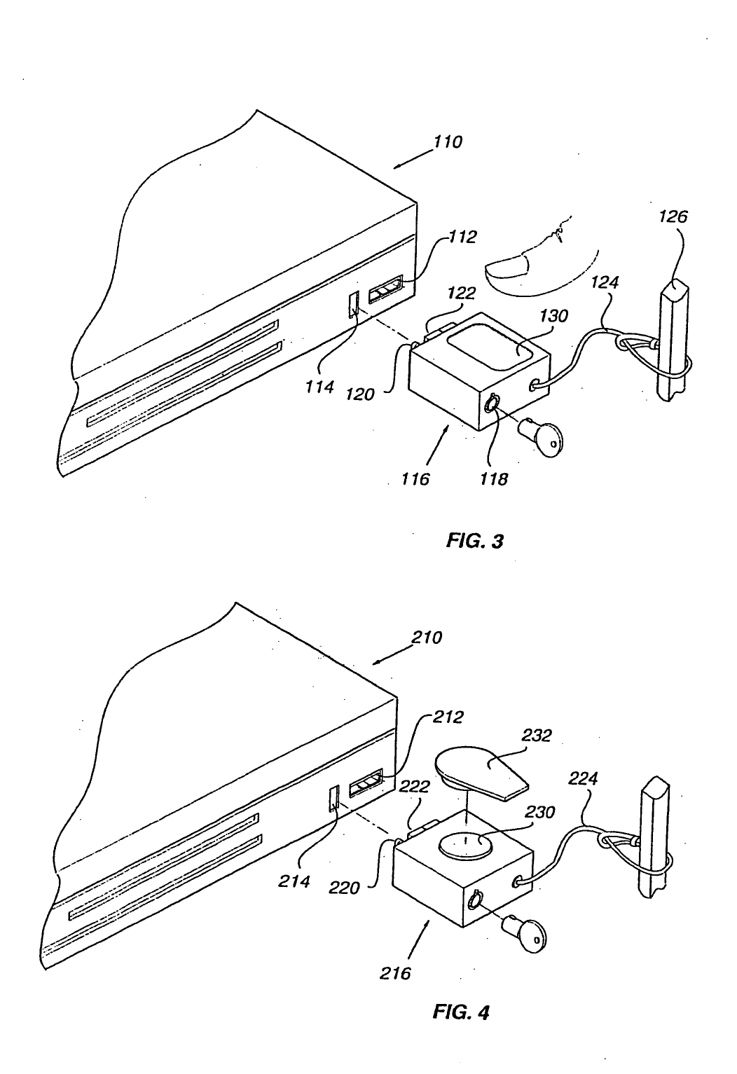

In the example illustrated in FIG. 3, the device 116 is further modified to operate as a fingerprint recognition system, using sensor platen 130.

Fingerprint recognition technology for security purposes is well known. In brief, a three stage fingerprint recognition method is employed whereby a finger is pressed against a sensor platen; is then displayed on the computer monitor of the owner to assure clear imaging thereof; and the image is digitized and memorized for future comparisons. Suitable dedicated software application is used to reject all fingerprints other than of the authorized person who previously programmed his/her fingerprint.

This routine will have to be applied to personalize the plug-in device 116 with respect to the computer that is wished to be protected.

As with respect to the former embodiment, the device can be used by itself, solely for the purpose of user protection, or, with the addition of the cable 124—also as anti-theft means.

In an analogous manner, the device 216 of FIG. 4 employs, for the purpose of enabling/disabling the computer 210, pre-coded proximity sensor 230 operable by touch actuator 232 as well-known in the relevant art (e.g. in connection with the so-called “immobilizers” of motor vehicles).

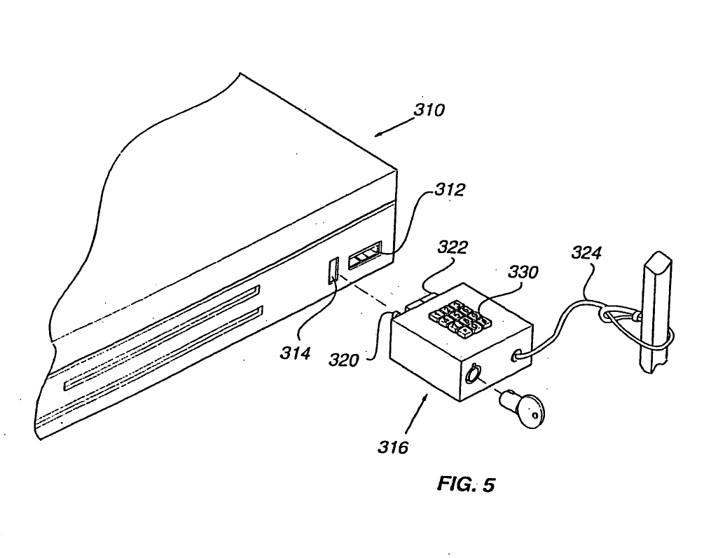

The electronic active component in the embodiment of FIG. 5 is a keyboard 330. Hence, in order to enable the computer 310, the legitimate user will have to enter a pre-set secret code.

Those skilled in the art will readily appreciate that numerous changes, variations, and modifications may be applied to the invention as heretofore exemplified without departing from the scope thereof as defined in and by the appended claims.

1. An arrangement for the protection of computers comprising, in combination,
A. A computer comprising:
(a) a socket comprised at a side wall thereof; and
(b) a dedicated slot formed at the side wall, at a distance from the socket; and
B. A plug-in device comprising:
(a) a casing;
(b) a plug projecting from one side wall of casing fitting the said socket;
(c) a rotatable T-shaped tip member fitting said slot projecting from said side wall, at the said distance from the plug; and
(d) a key or the like operable mechanism coupled to the tip member for rotation and locking thereof in a pre-set angular position,
whereby the plug-in device is adapted to become locked against the computer when plugged to the socket and the tip turned by less than 180°.

2. The arrangement of claim 1 wherein a cable is attached to the plug-in device at one end thereof and adapted to be tied by the other end thereof to a stationary object.

3. The arrangement of claim 2 wherein the socket is a USB socket.

4. The arrangement of claims 1-3 wherein electronic circuitry means are comprised in the plug-in device effective to input operation commands to the computer via the USB socket.

5. The arrangement of claim 4 wherein the operational commands include switching the computer from a disabled state into an enabled state.

6. The arrangement of claim 5 wherein the electronic circuitry means comprise control means.

7. The arrangement of claim 6 wherein the control means comprise a fingerprint recognition system.

8. The arrangement of claim 6 wherein the control means comprise a proximity sensing system.

9. The arrangement of claim 6 wherein the control means comprise a key-board system.
